(19) United States
(12) Patent Application Publication
(10) Pub. No.: US 2011/0083514 A1
(43) Pub. Date: Apr. 14, 2011

(54) THROUGH-FLOW MEASURING DEVICE

(75) Inventors: Martin Naier, Lustenau (AT); Reinhard Wipplinger, Hard (AT); Markus Schrittwieser, Dornbirn (AT)

(73) Assignee: KRAL AG, Lustenau (AT)

(21) Appl. No.: 12/902,235

(22) Filed: Oct. 12, 2010

(30) Foreign Application Priority Data
Oct. 9, 2009 (AT) A1593/2009

(51) Int. Cl. G01F 1/58; G01F 1/68

(52) U.S. Cl. 73/861.11; 73/204.17

(57) ABSTRACT

Flow-meter device (1) for the measurement of a flow of at least one fluid through a measurement chamber (3) arranged in a housing (2) of the flow-meter device (1). The flow-meter device (1) has at least one rotating element (4) that is mounted so that it can rotate and can be rotated by fluid flowing through the measurement chamber (3) and at least two rotation sensors (5) for the measurement of the rotation of the rotating element (4). The two rotation sensors (5) are arranged on a common sensor carrier (6) and another temperature sensor (7) is also arranged on the common sensor carrier (6).

### CROSS-REFERENCE TO RELATED APPLICATIONS

This application claims the benefit of Austrian Patent Application No. A1593/2009, filed Oct. 9, 2009, which is incorporated herein by reference as if fully set forth.

### BACKGROUND

1. Field of the Invention

The present invention relates to a flow-meter device for measuring a flow of at least one fluid through a measurement chamber arranged in a housing of the flow-meter device, wherein the flow-meter device has at least one rotating element that is mounted so that it can rotate and that can be rotated by fluid flowing through the measurement chamber and at least two rotation sensors for measuring the rotation of the rotating element.

2. Description of Related Prior Art

Flow-meter devices according to the class are used in very different fields. They are used for determining the flow of at least one fluid through a measurement chamber of the flow-meter device and thus through the flow-meter device. This can involve determining the quantity of flow, the flow rate, or parameters derived from these variables. The rotating element could be charged here directly by the fluid flowing through the measurement chamber. However, it is also possible that the rotating element, whose rotational movement is measured by the rotation sensor, is not itself arranged in the measurement chamber, but is instead connected to gearwheels, spindles, or the like mounted so that they can rotate there and is rotated by these elements.

A flow-meter device according to the class is known from WO 2005/119185 A1. Here the two rotation sensors are arranged spaced apart from each other in a housing of a measurement mechanism element.

### SUMMARY

The present invention provides a compact and universally usable arrangement for at least two rotation sensors.

According to the invention, the two rotation sensors are arranged on a common sensor carrier and another temperature sensor is also arranged on the common sensor carrier.

A compact arrangement is produced by the arrangement of the two rotation sensors on a common sensor carrier. Through the temperature sensor also arranged on the sensor carrier, it is possible to take into account or correct accordingly temperature-dependent density differences or fluctuations of the fluid to be measured in the flow measurement. Here, the flow-meter device can be used in a wide range of temperature regions or also for varying temperatures and thus can be used very universally. Through the arrangement of the temperature sensor on the common sensor carrier, a very compact construction is also produced, in turn. Through the compact construction, a correspondingly high strength can also be achieved. This is especially important when the sensor and the sensor carrier come into direct contact with fluid at a high pressure. Whether a pressure connection exists between the measurement chamber and the sensors or the sensor carrier depends on the corresponding embodiment.

The rotating element can be charged in the measurement chamber directly by the fluid flowing through the measurement chamber. Alternatively, it is also possible that a different rotating element is provided in the measurement chamber, wherein this element is connected to the rotating element and is rotated by the fluid flowing past. One possible embodiment provides, e.g., that the rotating element is connected to at least one measurement spindle that is mounted so that it can rotate in the measurement chamber and can be rotated by the fluid flowing through the measurement chamber.

With flow-meter devices according to the invention, the quantity of flow can be determined in the form of a volume and/or the flow rate can be determined in the form of a volume per unit of time and/or the direction of flow. In addition, parameters derived from these variables, such as, e.g., the mass of the flowing fluid, could be determined. It is also possible to determine different parameters characterizing the flow of the fluid through the measurement chamber with flow-meter devices according to the invention. For this purpose, it is favorable when the at least two rotation sensors measure the rotational speed and/or the direction of rotation of the rotating element.

An especially compact but also pressure-resistant construction can be achieved in that the rotation sensors and the temperature sensor are arranged on a common carrier plate, advantageously on a common carrier circuit board, of the measurement circuit carrier. In the sense of a compact construction, it is even possible that the rotation sensors are integrated in a common chip. Here, a chip is understood to be an electronic component or an electronic, integrated circuit in which one or more electronic circuits are housed on a common substrate. Suitable chips with at least two rotation sensors are known in the prior art. As an example to be noted here is the chip NVE ABL 014 from NVE Corporation, 11409 Valley View Road, Eden Prairie, Minn. 55344 USA.

Especially preferred embodiments of the invention provide that the sensor carrier can be mounted or is mounted on and/or in the housing of the flow-meter device in an exchangeable way by a non-destructive, detachable connection device. In this way it is possible to easily exchange the sensor carrier or to remove it from the housing of the flow-meter device for assembly or maintenance measures and to reinstall it. A non-destructive, detachable connection device is here understood to be a device that is suitable and/or provided for multiple connection and repeated detachment, without here the sensor carrier or the housing or the parts connecting them to each other having to be destroyed. Examples for non-destructive, detachable connection devices are screw, snap closures, and the like. These could be activated by hand or else also exclusively with a tool. Detachable connection methods that are not non-destructive are, e.g., adhesion, welding, soldering, and the like.

So that the sensor carrier can be mounted only in a single, namely the desired or correct position on and/or in the housing of the flow-meter device, preferred embodiments of the invention provide that the sensor carrier and/or the housing of the flow-meter device has (have) a positioning device by which the sensor carrier can be mounted exclusively in a single end position on and/or in the housing of the flow-meter device.

### BRIEF DESCRIPTION OF THE DRAWINGS

Additional features and details of preferred embodiments of the invention will be further explained in detail with reference to the following description of the figures.

Shown are:

FIG. 1 is a partial section view of a flow-meter device according to the invention;

FIG. 2 is a view of the flow-meter device from FIG. 1, but without the connector box;

FIG. 3 is a view of the sensor carrier of this embodiment according to the invention;

FIG. 4 is a section view through the flow-meter device, the connector box, and the sensor carrier;

FIG. 5 is an enlarged cutout from FIG. 4 in the area of the sensor carrier and the rotating element;

FIG. 6 is a view showing parts of the sensor carrier and the rotating element;

FIG. 7 is a schematic circuit diagram;

FIG. 8 is a schematic diagram on details of the sensor and its circuits;

FIGS. 9a to 9c are diagrams of the output signals of the rotation sensors and their evaluation;

FIG. 10 is a schematic flowchart for the evaluation of the output signals measured with the rotation sensors.

### DETAILED DESCRIPTION OF A PREFERRED EMBODIMENT

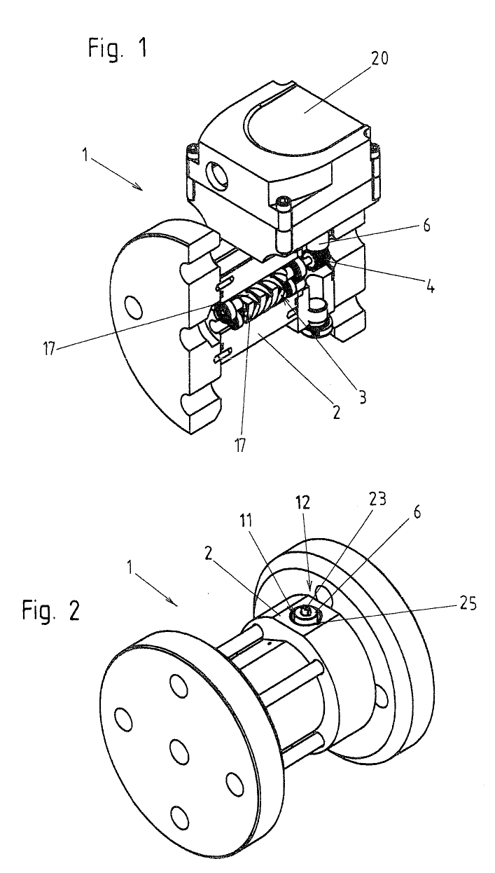

FIG. 1 shows a longitudinal section along a measurement spindle 17 through the housing 2 of the embodiment of the flow-meter device 1 according to the invention. The measurement spindles 17 are located in the measurement chamber 3 of the flow-meter device 1 which carries a flow of the fluid. When the fluid whose flow is to be measured is flowing through the measurement chamber 3, the measurement spindles 17 are rotated. The number of revolutions of the measurement spindles reflects the quantity of the fluid that is flowing. The direction of rotation of the measurement spindles 17 reflects the direction of flow of the fluid. The rotating element 4 is connected locked in rotation with one of the spindles and is constructed as a gearwheel in the illustrated embodiment. Other constructions of the rotating element are also possible. If the measurement spindle 17 is rotating, then the rotating element 4 is also rotated. Thus, the direction of rotation and the number of rotations of the rotating element 4 likewise reflect the quantity of fluid that is flowing and the direction of flow. Such structural systems are known for flow-meter devices according to the prior art. Therefore it will not be discussed in more detail. The same applies for the feed and discharge channels that lead to the measurement chamber 3 and back away from this chamber. These could also be arranged and constructed as in the prior art.

The sensor carrier 6 is arranged in the housing 2 or in a receptacle channel 11 of the housing 2 of the flow-meter device 1, as is to be seen in FIG. 1. This will be discussed in more detail farther below. A connector box 20 is arranged in the illustrated embodiment on the outside on the housing 2 of the flow-meter device 1. On one hand, this can protect the connections 23 of the sensor carrier 6. On the other hand, the connector box could also house the evaluation device or evaluation electronics for the evaluation of the measured signals explained in detail farther below. In addition, the connector box 20 could also be used to connect the connections 23 of the sensor carrier 6 to continuing cables.

FIG. 2 shows a view from the outside on the housing 2 of the flow-meter device constructed according to the invention according to FIG. 1, wherein, however, the connector box 20 has been removed. The rear end of the sensor carrier 6 facing away from the rotating element 4 in the operating position with its connections 23 is shown. The sensor carrier 6 is located in the diagram according to FIG. 2 in the receptacle channel 11 of the housing 2 of the flow-meter device 1. The sensor carrier 6 can be inserted in the insertion direction 12 into the receptacle channel 11 and can be mounted by a non-destructive, detachable connection device 10 explained farther below. At the edge of the receptacle channel 11, the outer end of the groove 25 is also shown that forms a portion of the groove-and-peg guide 14 explained farther below.

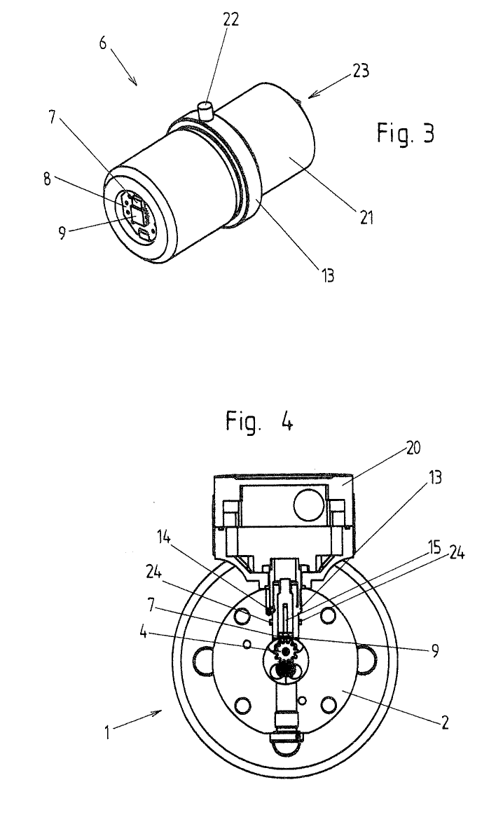

FIG. 3 shows the sensor carrier 6 in a state in which it has been removed from the receptacle channel 11 and thus the housing 2 of the flow-meter device 1. In the illustrated embodiment, the sensor carrier 6 has an approximately cylindrical sensor carrier housing 21. This could be made, e.g., from metal, in particular, a stainless metal, such as, e.g., stainless steel, or could include such materials. In the illustrated embodiment, the stop 13 that is annular in this embodiment and also the peg or pin 22 are formed on this sensor carrier housing 21 approximately in the center. Both the stop 13 and also the peg 22 form parts of the positioning device explained in more detail farther below by which the sensor carrier 6 can be mounted exclusively in a single end position on and/or in the housing 2 of the flow-meter device 1. The chip 9 and, directly adjacent to this chip, the temperature sensor 7 are arranged on the sensor carrier 6 in the end region of the sensor carrier 6 facing the rotating element 4 in the installed position. Both rotation sensors 5 are integrated in the chip 9 of this embodiment, as explained in detail farther below. The chip 9 and the temperature sensor 7 are arranged together on the carrier plate 8 at the end of the sensor carrier 6 facing the rotating element 4 in the operating position. The carrier plate 8 could be constructed from plastic or could include plastic. For example, it could involve a carrier circuit board for electric circuits. Through the shown compact construction, a high strength is achieved. The circuit board forming the carrier plate 8 can be a 3D circuit board that leads the track conductors in the interior of the sensor carrier housing 21 backward to the electrical connections 23. The connections 23 are used for electrical contacting and represent the interface between an evaluation device or its wiring advantageously arranged in the connector box 20 and the sensors 7 and 9 or 5. The connections 23 are preferably arranged, as shown here, at the end of the sensor carrier 6 opposite the temperature sensor 7 and the chip 9 or the rotation sensors 5. In a refined embodiment of the invention, not shown here, it can be provided that the temperature sensor 7 and the chip 9 or the rotation sensors 5 are covered by a membrane. This prevents these electrical components or the carrier plate 8 carrying them from being able to be attacked by chemically aggressive fluids. It can involve, e.g., a thin metal membrane made from stainless steel. This can be, e.g., 0.2 mm thick, without disrupting the measurement process. If such a protective membrane is provided then it preferably covers the entire area of the chip 9 or the rotation sensors 5, the temperature sensor 7, and the carrier plate 8, so that no fluid can reach the sensors directly.

Deviating from the illustrated embodiment, other sensors, e.g., for the measurement of pressure and/or density and/or viscosity can also be arranged on the carrier plate 8 in addition to the temperature sensor 7 and to the rotation sensors 5 or the chip 9. These additional sensors are then likewise also integrated in the common sensor carrier 6.

Through the combination of the different sensors 5 and 7 in a sensor carrier 6 it is avoided that, for their mounting, various additional boreholes, e.g., at different angles and at different positions are required for the mounting of the sensors. Furthermore, difficulties of combining the signals and the protection of the sensor are avoided. In addition, difficulties with the prevention of the electromagnetic effect of the sensor due to the necessary wiring are also stopped in advance.

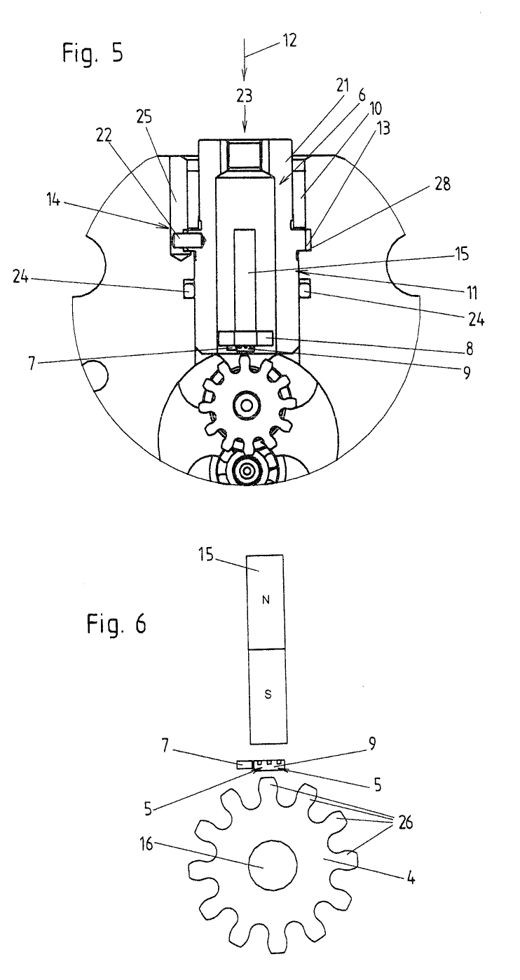

FIG. 4 shows a section through the housing 2 of the measurement device 1 in the area of the sensor carrier 6 mounted in the housing 2 or in the receptacle channel 11. The illustrated section plane stands normal to the longitudinal extent of the measurement spindle 17 shown in FIG. 1. FIG. 5 shows a partial area of this section from FIG. 4 enlarged. The sensor carrier 6 is inserted in the insertion direction 12 in the receptacle channel 11 arranged in the housing 2. While inserting or pushing the sensor carrier 6 in the insertion direction 12 into the receptacle channel 11, an end position is reached when the stop 13 of the sensor carrier 6 comes into contact with the stop 28 of the housing 2. Through the interaction of the two stops 13 and 28, the ability to insert the sensor carrier 6 into the receptacle channel 11 in the insertion direction 12 is thus limited. In this way, in the end position, the spacing between the rotation sensors 5 integrated in the chip 9 and the rotating element 4 is very easily and also very exactly set. The stop 13 and also the counter stop 28 thus form parts of a positioning device that ensures that the sensor carrier 6 can be mounted exclusively in a single end position on and/or in the housing 2 of the flow-meter device 1. Generally speaking, in this connection it is thus provided that the housing 2 of the flow-meter device 1 and/or the sensor carrier 6 advantageously each have at least one stop 13, 28 as part of the positioning device, wherein this stop limits the ability of the sensor carrier 6 to be inserted into the receptacle channel 11 in the insertion direction 12.

In order to also avoid unintentional twisting of the sensor carrier 6 during installation in the receptacle channel 11, the positioning device preferably also provides a groove-and-peg guide 14 on the housing 2 of the flow-meter device 1 or on the sensor carrier 6 that stops twisting of the sensor carrier 6 in the receptacle channel 11, advantageously in a direction about the insertion direction 12. Here, the groove 25 of the groove-and-peg guide 14 could be cut into the housing 2 of the flow-meter device 1 and the peg 22 could be fixed on the sensor carrier 6. This corresponds to an embodiment that is shown particularly well in FIG. 5 and is realized in the illustrated embodiment. Naturally, it is also possible as well that a corresponding groove 25 is located in the sensor carrier 6 and the peg 22 engaging in this groove is fixed on the housing 2 of the flow-meter device 1. In addition, other embodiments of corresponding positioning devices are also possible. For example, the stops 13 and 28 could also be integrated equally in the groove-and-peg guide 14. The common feature is the creation of various possibilities of corresponding positioning devices such that, in any case, they allow the installation of the sensor carrier 6 exclusively in a single end position on and/or in the housing 2 of the flow-meter device 1, with which incorrect mounting is avoided and after successful installation of the sensor carrier 6, the rotation sensors 5 and the temperature sensor 7 are always positioned exactly for the operation and no-error measurement. To mount the sensor carrier 6 in a non-destructive, detachable way on and/or in the housing 2, the connection device 10 is provided. In the illustrated embodiment, it involves a screw sleeve that is inserted into the shown end position after the sensor carrier 6, screwed into the receptacle channel 11, and thus fixes the stop 13 of the measurement carrier 6 on the stop 28 of the housing 2 of the flow-meter device 1. In the illustrated embodiment, a corresponding tool could be set on the screw sleeve 10 from the outwardly open side of the receptacle channel 11, in order to rotate this sleeve. For example, the screw sleeve 10 could here have, on its end facing away from the stop 13, corresponding slots or the like in which corresponding areas of the tool not shown here can engage. This is naturally only one of many examples for how the sensor carrier 6 could be mounted on and/or in the housing 2 of the flow-meter device 1 in a non-destructive, detachable way by a connection device 10.

In FIG. 5, the seal 24 is also shown in the section diagram, wherein this seal prevents fluid from being able to be discharged past the sensor carrier 6 through the receptacle channel 11 from the housing 2 of the flow-meter device 1.

In the illustrated embodiment, a magnet 15, in the present case, a permanent magnet, for generating a magnetic field is arranged within the sensor carrier 6. However, it does not absolutely have to be provided that the sensor carrier 6 has the magnet 15. It is just as good that the housing 2 of the flow-meter device 1 has the magnet 15. In each of these cases, the magnet 15 is provided in any case to generate a magnetic field that is distorted or changed by the rotation of the rotating element 4. In the illustrated embodiment, the teeth 26 of the rotating element 4 constructed as a gearwheel are primarily responsible for these disruptions of the magnetic field.

FIG. 6 shows schematically that the magnet 15 is preferably arranged on the side of the rotating element 4 facing away from the sensors 5 and 7. As will be understood from FIG. 6, it is preferably provided that the rotation sensors 5 or the chip 9 holding it is spaced apart in the radial direction from the rotating element 4 with respect to its axis of rotation 16 about which the rotating element 4 can rotate. However, it could be provided just as well that an arrangement is selected in which, viewed with respect to the axis of rotation 16, the rotating element 4 is spaced apart in the axial direction or radial and axial directions from the rotation sensors 5. The spacing between the rotation sensors 5 is preferably selected so that the two rotation sensors 5 generate a signal phase-shifted by 90° when the rotating element 4 rotates due to flow. In the construction according to the invention, it is possible to measure different types of rotating elements 4 or embodiments of their teeth 26 spaced apart in the axial or radial direction with a single sensor carrier 6 and chip 9 arranged on this carrier or rotation sensors 5 and temperature sensor 7. Through the mentioned positioning device, a unique position is always achieved with respect to switching distance and orientation, which allows a simple ability to exchange the sensor carrier 6 together with the sensors 5 and 7.

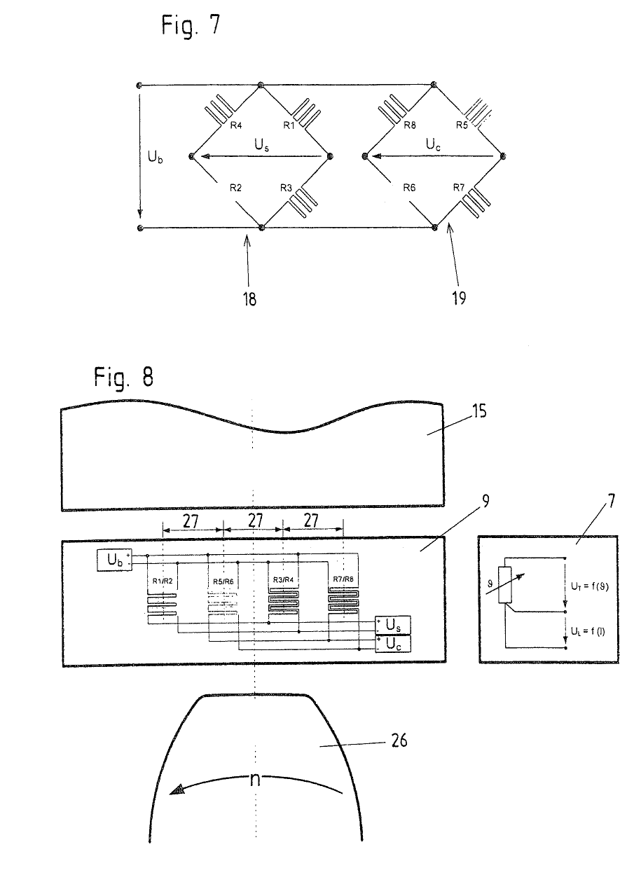

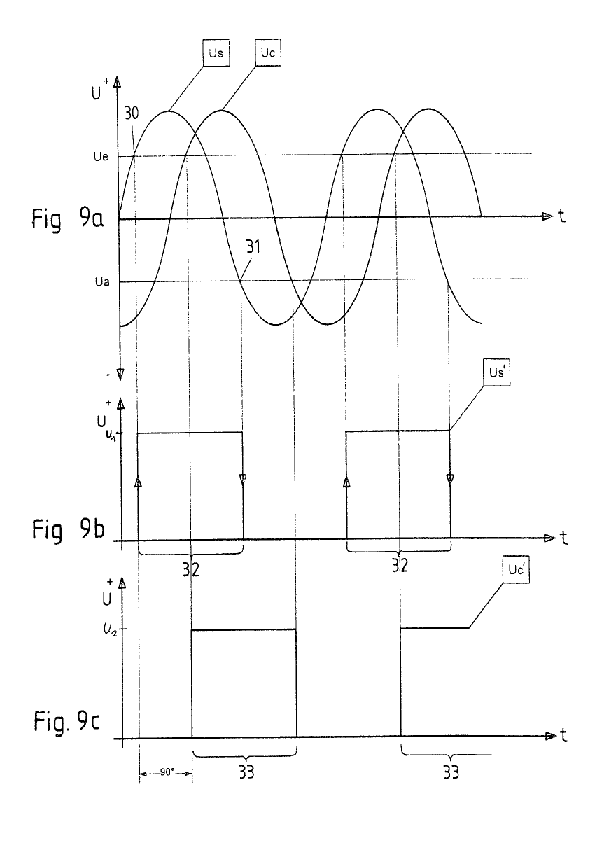

FIG. 7 shows schematically a possible circuit for the two rotation sensors 5. FIG. 7 is here used purely for the basic understanding of the circuit and does not reproduce the actual physical embodiment of the rotation sensors 5 and their arrangement relative to each other. As is to be taken from FIG. 7, each of the rotation sensors 5 have a measuring-bridge circuit 18 or 19. In the illustrated embodiment, the measuring-bridge circuit 18 forms the first rotation sensor 5 and the measuring-bridge circuit 19 forms the second rotation sensor 5. Both are constructed as Wheatstone bridges and are supplied with the operating voltage U_{b}. Each of the measuring-bridge circuits 18 and 19 has 4 resistors R1 to R4 and R5 to R8, respectively, which are wired to each other. These electrical resistors change their electrical resistance as soon as an outer magnetic field applied to them changes. The output signals U_{S} and U_{C} of the two measuring-bridge circuits 18 and 19 each reproduce a magnetic field strength and/or their changes of a magnetic field measured by the corresponding rotation sensor. In the illustrated embodiment, the output signals Uₛ and U_{c} involve voltages tapped at the corresponding positions. The magnet 15 generates a magnetic field that is disturbed or temporarily changed by the rotation of the rotating element 4 or the movement of a tooth 26 past the chip 9. The rotation sensors 5 or its measuring-bridge circuit 18 and 19 measure this change of the magnetic field caused by the rotating element 4 and here generate the output signals Uₛ and U_{c}. Through the correspondingly spaced-part arrangement of the two rotation sensors 5 or measuring-bridge circuit 18 and 19, output signals Uₛ and U_{c} shifted by 90° relative to each other are produced. In the illustrated embodiment, as shown as an example in FIG. 9a, both output signals are sinusoids. When the rotational speed of the rotating element 4 about its axis of rotation 16 changes, the frequency or period of the output signals of Uₛ and U_{c} changes, but not their phase shift relative to each other.

The parameter of the phase shift between the two output signals Uₛ and U_{c} is specified by the spatial offset between the rotation sensors 5 or their measuring-bridge circuits 18 and 19. In order to generate signals phase-shifted by 90°, this offset 27 preferably lies between 0.2 and 0.8 mm, especially preferred between 0.4 and 0.6 mm. In the illustrated embodiment, the offset 27 equals 0.5 mm.

FIG. 8 shows again schematically and enlarged the arrangement of magnet 15, the chip 9 holding the two rotation sensors 5 or their measuring-bridge circuits 18 and 19, and the temperature sensor 7 in relation to a tooth 26 of the rotating element 4 guided past this sensor. FIG. 8 shows likewise schematically how in reality the resistors A1 to A8 of the two measuring-bridge circuits 18 and 19 are arranged one superimposed on the other, in order to generate the distance 27 between the rotation sensors 5 and thus the phase shift between their output signals. As mentioned above, such chips 9 also designated as GMR twin sensors are available on the market, e.g., under the trade name NVE ABL 014. The temperature sensor 7 could preferably involve, as indicated likewise schematically in FIG. 8, a three-wire resistance sensor. The ohmic resistance of this temperature sensor changes as a function of temperature. This resistance could be measured in the form of U_{T} as a function of temperature θ. By means of the third wire or the voltage U_{L}, the characteristic impedance values can be taken into account. In this way, as is known in the prior art, a very precise temperature measurement is possible. The measured temperature is used, as explained farther below, for temperature compensation of the calculated flow parameters, with which the temperature dependency of the density of the fluid flowing through the measurement chamber 3 can be taken into account and thus a high-precision flow measurement can be performed.

FIGS. 9a to 9c each show diagrams in which a voltage U is plotted against time t. FIG. 9a shows, as examples and schematically, the output signals Uₛ and U_{c} of the two rotation sensors 5 or their measuring-bridge circuits 18 and 19. For further processing, these sinusoid signals are converted into square-wave signals in the illustrated embodiment by use of a so-called Schmitt trigger known in the prior art. FIG. 9b shows the time profile of the square-wave signal Uₛ′ generated by use of the Schmitt trigger 29 from Uₛ. FIG. 9c shows the square-wave signal U_{c}′ generated accordingly from U_{c} by use of the Schmitt trigger. The two square-wave signals shown in FIGS. 9b and 9c are also phase-shifted by 90°. For converting the sine-wave-shaped or cosine-wave-shaped signals Uₛ and U_{c} into the square-wave signals Uₛ′ and U_{c}′, the Schmitt trigger operates, in the present example, voltage values Uₑ and Uₐ that are selected, in the shown example, symmetric about the zero position of U. Here, in the illustrated embodiment, a pulse-pause ratio of 1:1 is achieved in the square-wave signals U_{S}′ and U_{C}′. When the signal U_{S} reaches the threshold Uₑ the first time (see FIG. 9a) at point 30, then the Schmitt trigger switches the voltage U_{S}′ from zero to a predetermined value U₁. If the voltage Uₐ is then reached (at point 31) the first time after the zero crossing of the signal U_{S} (see FIG. 9a), then U_{S}′ is reset to the voltage zero by the Schmitt trigger (see FIG. 9b). This process repeats as soon as the output signal U_{S} reaches the switching voltage Uₑ again the first time, etc.

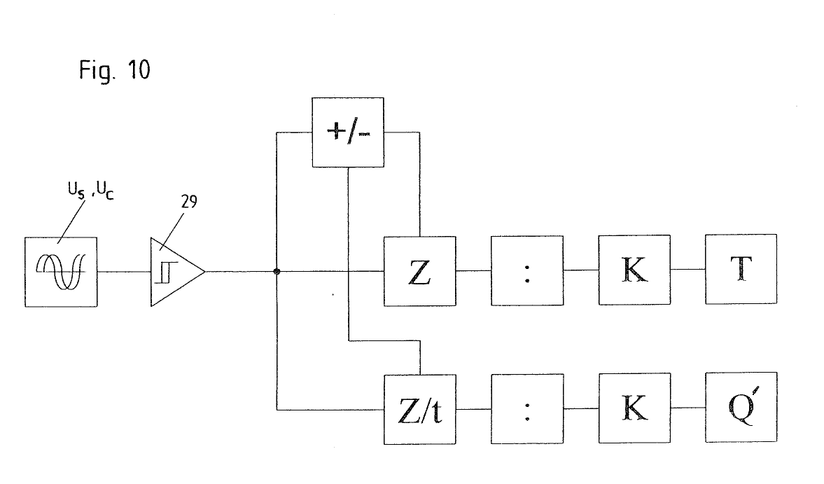

The square-wave signal U_{C}′ from the output signal U_{C} by use of the Schmitt trigger is generated analogously, wherein, however, the switching points from U=0 to U₂ (see FIG. 9c) are phase-shifted by 90° to the square-wave signal U_{S}′. The pulses 32 and 33 generated in this way each represent a defined quantity of flow, that is, a defined volume of the fluid flowing through the measurement chamber 3. The total quantity of flow through the measurement chamber 3 during a certain time interval is given by summing the number of pulses and conversion by a calibration factor, as explained below with reference to FIG. 10. For determining the number of pulses per unit of time, initially it is sufficient to use only one of the signals U_{S}′ or U_{C}′. In order to be able to also determine the direction of flow and thus also to be able to recognize a reversal of the direction of flow, both signals U_{S}′ and U_{C}′ are evaluated together. By monitoring the flank of the first signal U_{S}′ rising from zero to U₁ and the simultaneous consideration of the status of the second signal U_{C}′, as known in the prior art, a determination of the direction of rotation of the rotating element 4 and thus the direction of flow is possible.

FIG. 10 shows schematically a possible evaluation scheme that can be carried out by a suitable evaluation device based on the procedure mentioned with reference to FIGS. 9a to 9c. Initially the output signals U_{S} and U_{C} of the measuring-bridge circuits 18 and 19 or the rotation sensors 5 are converted by use of the

Schmitt trigger 29 into pulse series U_{S}′ and U_{C}′. Then the number Z of pulses 32 or 33 is counted over a certain period. Here, indicated by “+/−” in FIG. 10, the direction of rotation is taken into consideration by comparison of the signal series U_{S}′ and U_{C}′. If the determined direction of rotation of the rotating element 4 is constant, then the pulses 32 or 33 are summed. If the direction of rotation of the rotating element 4 inverts and thus causes an inverted direction of flow, then the pulses 32 or 33 are subtracted again as long as this direction of rotation prevails. The Z value determined in this way thus reflects the number of pulses over a certain period under consideration of the direction of rotation and thus the direction of flow of the fluid through the measurement chamber 3. In order to calculate the quantity of flow within a certain period, the number of pulses Z determined in this way is divided by a calibration factor K. This calibration factor is set in advance in a corresponding calibration process and indicates what quantity of flow or what volume corresponds to a pulse 32 or 33. Through the division Z/K, the quantity of flow T or the volume of the fluid that has flowed through the measurement chamber 3 during the period during which the pulses have been counted is given. In order to determine the flow rate Q′, that is, the quantity of flow per unit of time, an essentially analogous method is performed, but here the number of pulses per unit of time (Z/t) is used as the input parameter of the calculation. Through the vision by the calibration factor, the flow rate, that is, the quantity of flow per unit of time is produced. In this procedure, the density values or their changes due to temperature in the fluid flowing through the measurement chamber 3 have not yet been considered. In order to compensate the temperature effect, with reference to the temperature value measured by the temperature sensor 7 in the corresponding time interval, the density of the flowing fluid can be determined at the measured temperature or the measured temperature profile. For this purpose, reference can be made to corresponding table values, calibration curves, or calculation formulas known in the prior art. Through use of the density or the density profile determined in this way, the mass of fluid that has flowed through the measurement chamber 3 in this time interval can be determined from the determined quantity of flow T, as mentioned above. From Q′, the mass of flow of the fluid per unit of time can be calculated by using the density of the fluid determined as a function of the temperature. If this is desired, the quantities of flow or flow rates can be calculated, in turn, from the masses or masses per unit of time calculated in this way through the use of a density at a determined, given temperature of the fluid. As an alternative to this procedure of temperature compensation of the measurement results, it is also possible to determine the calibration factor K as a function of temperature. In this procedure, in the calculation according to FIG. 10, a K value selected as a function of the temperature measured by the temperature sensor 7 could be referenced for calculating the quantity of flow T or flow rate Q′. Independent of which of the proposed procedures is now used for temperature compensation, the temperature sensor 7 integrated according to the invention in the sensor carrier 6 allows the influences of the temperature of the fluid on its density to be taken into account in the determination of the quantities of flow or flow rates. Furthermore, the proposed system recognizes when reversals or changes in the direction of flow are produced, so that here no errors can be produced in the calculated quantities of flow or flow rates or parameters derived from these variables.

Legend to the reference symbols:

1 Flow-meter device

2 Housing

3 Measurement chamber

4 Rotating element

5 Rotation sensor

6 Sensor carrier

7 Temperature sensor

8 Carrier plate

9 Chip

10 Connection device

11 Receptacle channel

12 Insertion direction

13 Stop

14 Groove and peg guide

15 Magnet

16 Axis of rotation

17 Measurement spindle

18, 19 Measuring-bridge circuit

20 Connector box

21 Sensor carrier housing

22 Peg

23 Connections

24 Seal

25 Groove

26 Tooth

27 Offset

28 Stop

29 Schmitt trigger

30 Point

31 Point

32 Pulse

33 Pulse

U_{S}, U_{c} Output signal

U_{S}′, U_{c}′ Square-wave signal

Uₑ, Uₐ Switching voltages

U₁, U₂ Specified value

U_{b} Operating voltage

1. A flow-meter device (1) for measuring a flow of at least one fluid through a measurement chamber (3) arranged in a housing (2) of the flow-meter device (1), the flow-meter device (1) comprises at least one rotating element (4) that is mounted so that it can rotate and can be rotated by fluid flowing through the measurement chamber (3) and at least two rotation sensors (5) for measuring a rotation of the rotating element (4), the two rotation sensors (5) are arranged on a common sensor carrier (6) and a temperature sensor (7) is also arranged on the common sensor carrier (6).

2. The flow-meter device (1) according to claim 1, wherein the rotation sensors (5) and the temperature sensor (7) are arranged on a common carrier plate (8) of the sensor carrier (6).

3. The flow-meter device (1) according to claim 2, wherein the common carrier plate (8) is a common carrier circuit board.

4. The flow-meter device (1) according to claim 1, wherein the rotation sensors (5) are integrated into a common chip (9).

5. The flow-meter device (1) according to claim 1, wherein the sensor carrier (6) can be mounted or is mounted on or in the housing (2) of the flow-meter device (1) in an exchangeable way by a non-destructive, detachable connection device (10).

6. The flow-meter device (1) according to claim 5, wherein the housing (2) of the flow-meter device (1) has a receptacle channel (11) in which the sensor carrier (6) is inserted in an insertion direction (12) and in which the sensor carrier (6) is mounted by the connection device (10).

7. The flow-meter device (1) according to claim 1, wherein the sensor carrier (6) or the housing (2) of the flow-meter device (1) has a positioning device by which the sensor carrier (6) can be mounted exclusively in a single end position on or in the housing (2) of the flow-meter device (1).

8. The flow-meter device (1) according to claim 6, wherein the sensor carrier (6) or the housing (2) of the flow-meter device (1) has a positioning device by which the sensor carrier (6) can be mounted exclusively in a single end position on or in the housing (2) of the flow-meter device (1) and the housing (2) of the flow-meter device (1) or the sensor carrier (6) as part of the positioning device has at least one stop (13, 28) that limits an ability to insert the sensor carrier (6) into the receptacle channel (11) in the insertion direction (12).

9. The flow-meter device (1) according to claim 6, wherein the sensor carrier (6) or the housing (2) of the flow-meter device (1) has a positioning device by which the sensor carrier (6) can be mounted exclusively in a single end position on or in the housing (2) of the flow-meter device (1) and the positioning device has a groove-and-peg guide (14) on the housing (2) of the flow-meter device (1) or on the sensor carrier (6) that prevents twisting of the sensor carrier (6) in the receptacle channel (11).

10. The flow-meter device (1) according to claim 1, wherein the sensor carrier (6) or the housing (2) of the flow-meter device (1) has a magnet (15) for generating a magnetic field.

11. The flow-meter device (1) according to claim 10, wherein the magnet (15) is a permanent magnet.

12. The flow-meter device (1) according to claim 1, wherein the rotating element (4) is a gearwheel.

13. The flow-meter device (1) according to claim 1, wherein the rotation sensors (5) are spaced apart in a radial or axial direction from the rotating element (4) viewed with respect to an axis of rotation (16) about which the rotating element (4) can rotate.

14. The flow-meter device (1) according to claim 1, wherein the rotating element (4) is connected to at least one measurement spindle (17) that is mounted so that it can rotate in the measurement chamber (3) and is rotatable by fluid flowing through the measurement chamber (3).

15. The flow-meter device (1) according to claim 1, wherein each of the rotation sensors (5) has a measuring-bridge circuit (18, 19) whose output signals (Us, Uc) reproduce a magnetic field strength or a change in a magnetic field measured by each of the rotation sensors (5).

16. The flow-meter device (1) according to claim 1, wherein the rotation sensors (5) or measuring-bridge circuits (18, 19) of the rotation sensors (5) are arranged offset spatially relative to each other.

17. The flow-meter device (1) according to claim 16, wherein the offset equals between 0.2 mm and 0.8 mm.

18. The flow-meter device (1) according to claim 1, wherein the rotation sensors (5) output signals (Us, Uc) phase-shifted by 90° relative to each other when the rotating element (4) is rotating.

19. The flow-meter device (1) according to claim 1, wherein the rotation sensors (5) output sinusoid output signals (Us, Uc) when the rotating element (4) is rotating.

20. The flow-meter device (1) according to claim 1, further comprising an evaluation device for temperature-corrected determination of a quantity of flow or flow rate or direction of flow of the fluid or parameters derived from these variables from a rotational speed and direction of rotation of the rotating element (4) on the basis of output signals (Us, Uc) of the rotation sensors (5).

21. A method for operating a flow-meter device according to claim 20, wherein the quantity of flow or the flow rate or the direction of flow of the fluid or parameters derived from these variables are determined by the evaluation device from the output signals (Us, Uc) of the rotation sensors (5), an effect of the temperature on the density of the fluid is determined by use of the temperature sensor and is taken into account or corrected during or after a determination of the quantity of flow or flow rate or the direction of flow of the fluid or parameters derived from these variables.
